(19) United States
(12) Patent Application Publication
(10) Pub. No.: US 2010/0023376 A1
(43) Pub. Date: Jan. 28, 2010

(54) Iterative real-time auction for resource management with user rules

(76) Inventor: Stephen J. Brown, Woodside, CA (US)

Correspondence Address: LUMEN PATENT FIRM, 350 Cambridge Avenue, Suite 100, PALO ALTO, CA, 94306, US

(21) Appl. No.: 12/220,909

(22) Filed: Jul. 28, 2008

(51) Int. Cl. G06Q 30/00; G06Q 50/00; G06Q 10/00

(52) U.S. Cl. 705/10; 705/14.25

(57) ABSTRACT

Resource management using an iterative real-time auction with user rules is provided. Users of a community, such as a multi-user development, establish user rules including conditions for operating a resource-consuming device based on an incentive. A utility manager receives the user rules and integrates them with respect to an incentive value. The aggregate resource demand of the community can be estimated based on the integration of the user rules and can be compared with a desired demand. By iteratively changing the incentive value and estimating the demand with respect to the incentive value, the utility manager can control resource demand and consumption while taking into account user preferences. In other words, users of the community provide bids for a resource auction based on incentives provided by the utility manager. Resources can include electricity and incentives can include financial incentives, carbon credits, or third party offers.

### FIELD OF THE INVENTION

The invention relates generally to resource management. More particularly, the present invention relates to an iterative real-time auction for resource management.

### BACKGROUND

Heating and cooling of residential and commercial buildings consumes an enormous amount of energy and is one of the greatest contributors to carbon dioxide emissions. In addition, heating and cooling can be problematic for energy suppliers, particularly during extreme weather conditions, as many consumers in a region require large amounts energy simultaneously, creating peak demand periods that can overwhelm the capacity of the energy suppliers. Certain energy resources, such as electricity, have limited energy storage capability; therefore balancing the energy load during peak demand periods is an important and difficult task.

High energy demands often force energy providers to use rolling blackouts to balance the load. In addition to stopping businesses and causing inconveniences, blackouts can cause public health problems, particularly for elderly consumers. To avoid having to rely on rolling blackouts, energy providers typically rely on altering the supply side of the balancing equation. For example, providers purchase backup capacity from other sources, such as coal, oil, or natural gas-based electricity producers. However, these sources of additional energy are financially costly to the energy providers and the consumers. Furthermore, these additional energy sources produce a large amount of carbon dioxide and other greenhouse gases.

Heating and cooling systems typically include thermostats to allow users to set the desired temperatures. Many attempts have been made to remotely monitor and manage thermostats to manage energy consumption. These solutions are typically command and control systems that enable a utility to reduce power demand by forcing settings onto consumer devices. However, existing solutions fail to account for consumer preferences and the individualized needs of each consumer.

The present invention addresses at least the difficult problems of resource management and advances the art with an auction for resource management.

### SUMMARY OF THE INVENTION

The present invention is directed to utility resource management of a community of users, such as a multi-user development or a utility district. A control module is provided for each user of the community to control a resource-consuming device of the user. A rules module is provided for allowing each user to establish one or more user rules related to the resource-consuming device and an incentive associated with a usage of the resource. In particular, the user rules include one or more conditions for operating the resource-consuming device with respect to an incentive. The user rules of some or all of the users are communicated to a utility manager. The utility manager establishes an offer value of an incentive based on one or more iterations of establishing a trial value and estimating a demand of the resource by the community. The demand is estimated by aggregating the user rules of some or all of the users of the community with respect to the trial value of the incentive. The offer value is established once a condition is satisfied between the estimated demand and a desired demand. The established incentive offer value is then communicated to the users, preferably through a communication network.

In a preferred embodiment, the iterative trial value establishment and demand estimation is accomplished continuously or periodically over time. The offer value can be changed based on a change to the estimated demand, a change to one or more of the user rules, a change to the desired demand, or any combination thereof. In an embodiment, the desired demand is changed based on the supply of the utility resource. Users of the community can be alerted when a change in the offer value occurs.

The utility resource can include an energy resource, electricity, a natural gas, a petroleum resource, a water resource, or any combination thereof. The incentive offered to the community can include a financial incentive, a carbon credit, a price for the utility resource, a third party offer, or any combination thereof. In a preferred embodiment, the resource-consuming device is a climate-controlling device, such as an air conditioner or a heater. A thermostat is provided for each user having a climate-controlling device and the user rules are related to one or more settings on the thermostat.

### BRIEF DESCRIPTION OF THE FIGURES

The present invention together with its objectives and advantages will be understood by reading the following description in conjunction with the drawings, in which:

FIG. 1 shows an example of an energy management system with an iterative real-time auction according to the present invention.

FIGS. 2A-B show examples of user rules according to the present invention.

FIG. 3 shows an example of a smart thermostat with thermostat modules according to the present invention.

FIG. 4 shows an example of a smart thermostat with user controls to input user rules according to the present invention.

FIGS. 5A-B show examples of bar charts with estimated demand as a function of incentive amount according to the present invention.

FIG. 6 shows an example continuous chart of estimated demand from the user rules as a function of resource price according to the present invention.

FIG. 7 shows a flow chart of an example iterative auction process for managing resources according to the present invention.

FIG. 8 shows a flow chart of an example user actions in the energy management system according to the present invention.

### DETAILED DESCRIPTION OF THE INVENTION

Managing resource consumption, particularly for balancing demand and supply, can be a difficult task. Current resource providers typically control the amount of resources consumed by managing the supply-side. For example, electric utility companies employ rolling blackouts to completely cut off electric power consumption of a neighborhood, thereby reducing the power demand during peak periods for the entire electric utility district. Obviously, blackouts are not desired by consumers and can even lead to casualties in extreme weather conditions. The present invention is directed to resource management with an iterative real-time auction with user-defined rules.

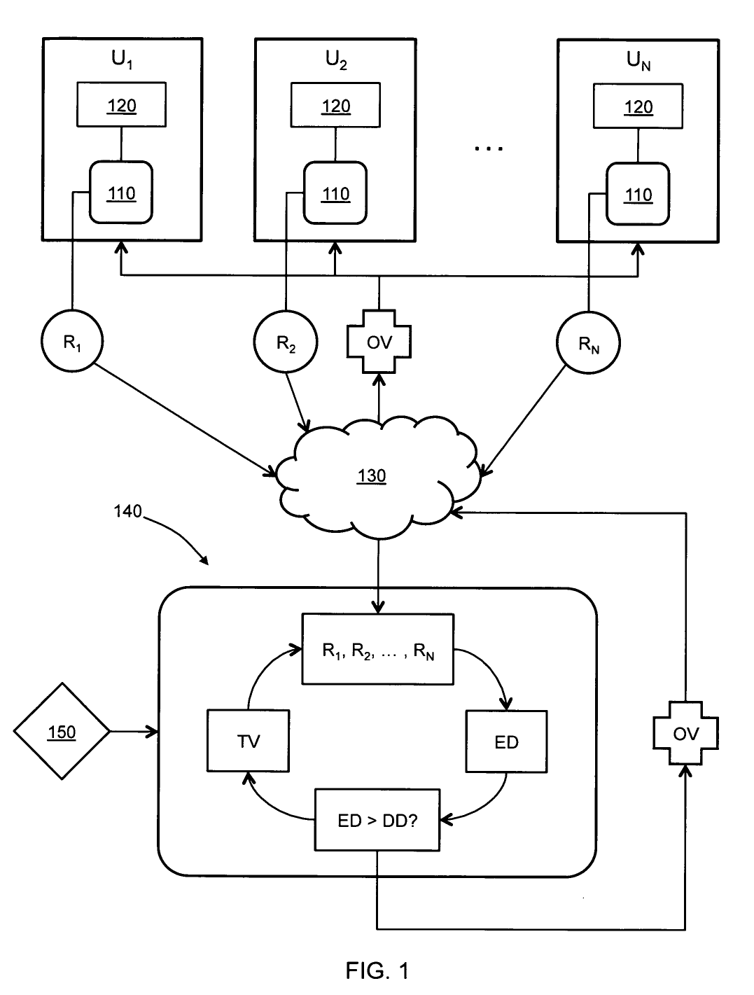

FIG. 1 shows an embodiment of a utility resource management system according to the present invention. The resource management system includes a community of users U₁-U_{N} and a utility manager 140, both connected to a communication network 130, such as the Internet. The community of users U₁-U_{N} can be any group of consumers of a resource, such as a building having multiple units, an apartment building, an office building, a retail development, a neighborhood, a housing development, an urban development, a suburban development, a district, a utility district, a city, or a county. Each user of the community has at least one resource-consuming device 120 that consumes a utility resource, such as an energy resource, electricity, a gas, a natural gas, a petroleum resource, a water resource, or any combination thereof.

It is important to note that a rules module 110 is provided to allow the users U₁-U_{N} of the community to establish user rules R₁-R_{N} related to the operation of the resource-consuming device 120. In particular, the user rules R₁-R_{N} established by a user include conditions for operating the resource-consuming device 120 of the same user. Importantly, the user rules R₁-R_{N} are related to an incentive directed to the operation of the resource-consuming device 120. In an embodiment, a control module is provided for each user to control the activity of the resource-consuming device 120 based on the user rules R₁-R_{N} and with respect to an incentive.

The user rules R₁-R_{N} are communicated to the utility manager 140, preferably through the network 130. The utility manager 140 receives the user rules R₁-R_{N} of some or all of the users U₁-U_{N} of the community. The utility manager 140 establishes a trial value TV of an incentive and estimates a demand ED of the utility resource by the community based on the user rules R₁-R_{N}. In other words, the utility manager 140 integrates the user rules R₁-R_{N} with respect to the trial value TV to determine an estimated aggregate demand ED of at least a part of the community. The estimated demand ED is compared with a desired demand DD to determine if the trial value TV requires changing. If the comparison of the estimated demand ED and the desired demand DD leads to necessary changes to the trial value TV, the process is iterated with a different trial value TV until a desired condition between the estimated ED and desired DD demands is satisfied.

In a preferred embodiment directed to electrical load balancing, the desired demand DD is related to a supply of electric power and the estimated demand ED must be less than the desired demand DD in order to avoid necessitating blackouts. However, alternative conditions can also be used, such as for economic motivation for the utility manager 140. Once the condition is met, the utility manager 140 establishes an offer value OV of the incentive. In an embodiment, the established offer value OV is equal to the trial value TV when the condition between the estimated ED and desired DD demands are satisfied.

Preferably, the utility manager 140 establishes the desired demand DD to serve any desired goal of the utility manager 140. In an embodiment, the utility manager 140 receives external data 150 and determines a desired demand DD based on the external data 150. Examples of external data 150 include information relating to the supply or capacity of the resource, current and projected weather data, financial data, and carbon data, such as data relating to carbon emission standards.

The incentive is offered to the community at the offer value OV, thereby influencing user behavior, e.g. reducing resource consumption by the users U₁-U_{N} of the community. The incentives can include a financial incentive, a carbon credit, a price or rate for the utility resource, a third party offer, or any combination thereof. In an embodiment, the community shares a total number of carbon credits and an incentive includes shares of the carbon credits. Third party offers can include discounts or coupons from third parties for products and services. For example, a third party can offer free or discounted warm clothing for users who choose to reduce their heating in the winter.

By using the iterative process with trial values TV and estimating the resource demand of the community based on the user rules R₁-R_{N}, the utility manager 140 can balance the needs of the community with interests of the utility manager 140. The trial values TV can be incrementally changed at any increment size. In a preferred embodiment, iteratively establishing the trial value TV of the incentive and estimating the demand are accomplished continuously over time to adjust the offer value OV approximately continuously in near real-time. Alternatively, the iterative offer value OV determination can be accomplished periodically over time. The offer value OV can be changed based on changes to the estimated demand ED, changes to the user rules R₁-R_{N}, changes to the desired demand DD, or any combination thereof.

In a preferred embodiment of the present invention, the resource-consuming device 120 of at least one of the users U₁-U_{N} is a climate-controlling device, such as a heating, venting, and air conditioning (HVAC) unit. The user having the climate-controlling device is also provided a thermostat associated with the climate-controlling device. The user rules R₁-R_{N} are related to one or more settings on the thermostat.

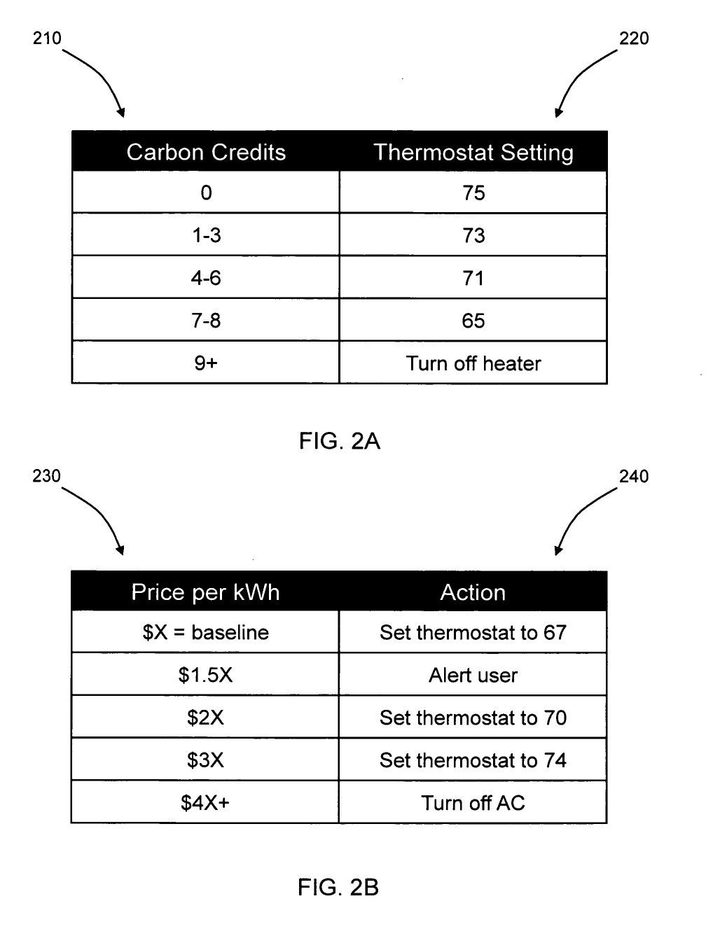

FIG. 2A shows examples of user rules related to thermostat settings 220 for a climate-controlling device. The user rules relate thermostat settings 220 to incentive amounts of carbon credits 210. More particularly, a user establishes the user rules of FIG. 2A to determine the user's willingness to reduce heating depending on the number of carbon credits 210 offered to the user. For example, if no carbon credits are offered, the user's thermostat settings 220 will be set to a high heating level of 75 degrees, if 1 to 3 carbon credits are offered, the thermostat setting 220 is lowered to 73 degrees, if greater amounts of carbon credits are offered, the thermostat setting 220 will be lowered further, and if 9 or more carbon credits are offered, the heater will be turned off altogether.

FIG. 2B shows another example of user rules related to user actions 240 in a warm climate environment where operation of an air conditioner is generally desired. The user rules of FIG. 2B rely on resource prices 230 instead of carbon credits. For example, if the price of electrical energy is at a baseline price of $X per kWh, the thermostat will be set to 67 degrees, if the price is raised to 1.5 times the baseline price, the thermostat will alert the user that the price has been changed and the user will have the opportunity to act upon this change, if the price per kWh is raised to twice the baseline price, the thermostat setting will be raised to 70 degrees (i.e. less cooling energy required), and if the price is raised further, the thermostat setting will be correspondingly increased or the air conditioner will be turned off.

The examples of user rules shown in FIGS. 2A-B allow the utility manager to adjust the amount of offered carbon credits and/or resource price to alter the thermostat settings and/or consumption of the user. Integrated over all user rules, the total resource demand of the community can be estimated. The user rules are effectively bids of user reduction of (or otherwise changes to) resource-consuming behavior in an auction associated with resource consumption.

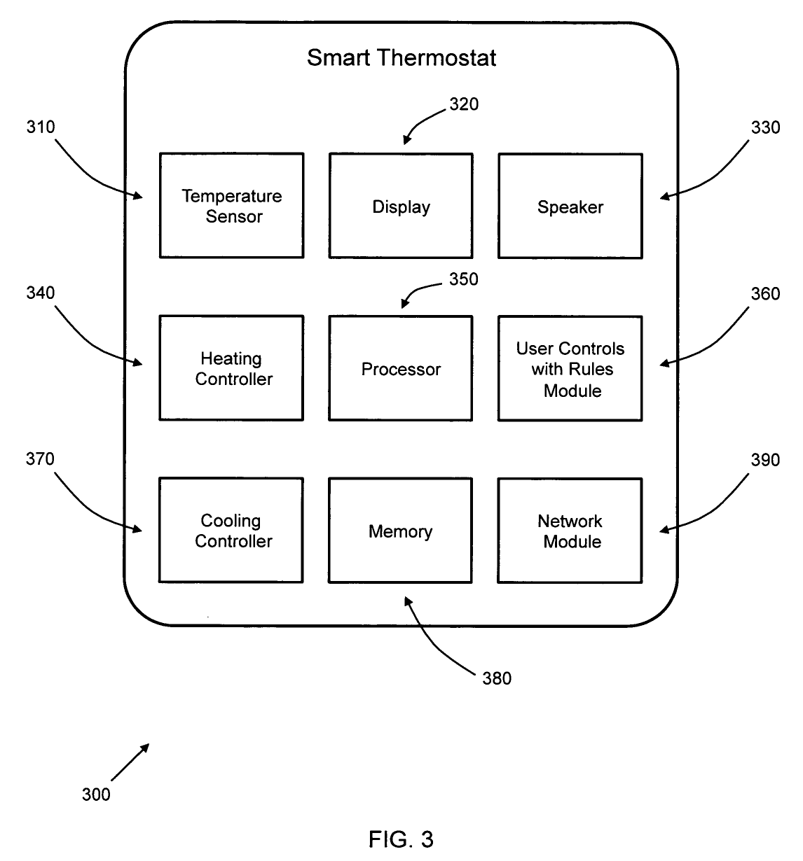

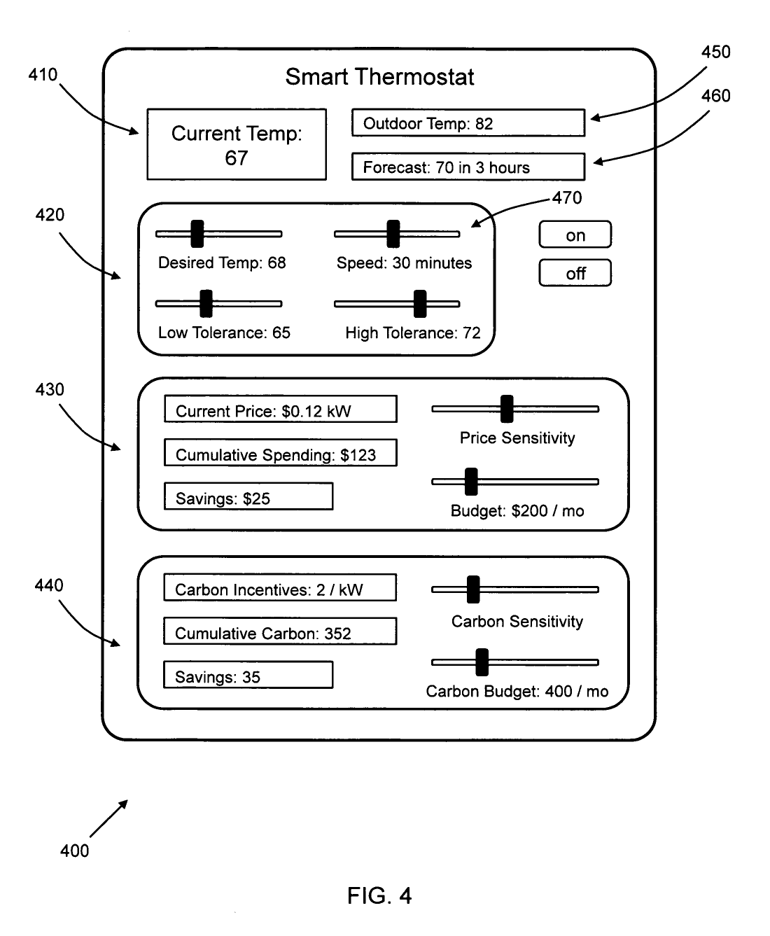

A user rule need not be restricted to thermostat settings, but can include any conditions for operating a climate-controlling or resource-consuming device. For embodiments relating to thermostats, FIG. 3 and FIG. 4 show example thermostats, including thermostat modules. The smart thermostat 300 of FIG. 3 includes a temperature sensor 310 for measuring the temperature of a room or building of the user. The heating 340 and cooling 370 controllers transmit signals to the heater and air conditioner, respectively, to control the activity of the device, such as variable heating and cooling levels and rates of heating and cooling. The heating 340 and cooling 370 controllers can transmit signals based on the temperature measured by the temperature sensor 310 and by the user rules.

The user control 360 allows the user to adjust thermostat settings, such as desired heating and/or cooling temperatures, and temperature ranges. In addition, the user controls 360 also allow the user to establish user rules, e.g. the example user rules shown in FIGS. 2A-B. The user control 360 can include a graphical user interface (GUI) for a computing device and/or include a button, a knob, sliders, or a touch screen located directly on the thermostat 300. User controls 360 can be processed by the processor 350, which directs the heating 340 and cooling 370 controllers. User-inputted settings and external data can be stored in memory 380, which is accessible by the processor 350. User settings and/or external data can be shown on a display 320, such as a liquid crystal display. The past, current, and/or future offer values can also be displayed.

It is important to note that the smart thermostat 300 includes a network module for connecting the smart thermostat 300 with a communication network and/or a utility manager via a communication network. The network connection can be through a cell phone network, a WIFI or other wireless network, a telephone line, a cable network, an Internet connection, a power line, or any other connection mechanism capable of transmitting and receiving data. In an embodiment, the network module 390 allows for connections between the smart thermostat 300 and a computing device, such as a personal computer, a personal digital assistant, or a laptop computer. Network connections allow the smart thermostat 300 to transmit user rules to the utility manager. Network connections also allow the user to receive the offer value provided by the utility manager. The processor 350 can be used to process the heating and cooling controls based on the received offer value and the user rules. Optionally, the network connections allow a user to receive external data, such as weather data, and process the heating and cooling controls based on the external data in combination with the user rules and offer value.

In an embodiment, the smart thermostat also includes a speaker 330 or another audio-visual mechanism to alert users of any relevant changes, such as changes to the offer value, or after thresholds for initiating one or more user rules have been reached. The alerts may occur while the user is inputting desired settings and/or after the utility manager has communicated incentive changes, including a change to the offer value.

FIG. 4 shows an exemplary embodiment of a smart thermostat 400 of a user of the community according to the present invention. The smart thermostat 400 includes a display of the current temperature in the room 410, the desired temperature settings 420, user rules relating to pricing data 430, user rules relating to carbon emissions 440, and external data, such as current 450 and projected 460 outdoor temperatures. The thermostat settings can include user rules relating to temperature tolerances and desired rates of heating/cooling 470.

In a preferred embodiment, a rules module is provided to allow a user to establish user rules related to a financial budget of the user. The financial user rules can be associated with current energy prices or rates as communicated to the smart thermostat 400 by the utility manager. Similarly, in an embodiment, the rules module is provided to allow a user to establish user rules related to a carbon budget. In an embodiment, the thermostat settings are automatically adjusted based on the user rules and communicated offer value. The adjustments to the thermostat settings can be done continuously or periodically depending on changes to the offer value and user rules.

In an embodiment, user inputs allowed by the rules module include sensitivity to price and/or carbon emissions, where the sensitivity is used to weight the external price and/or carbon in calculating periodic financial and carbon budgets, respectively. The financial savings, cumulative spending, carbon savings, and carbon emissions can be calculated by the smart thermostat 400 or can be communicated to the thermostat 400 by the utility manager, a third party, or by another processor. Carbon savings can include financial savings or savings in terms of carbon credits.

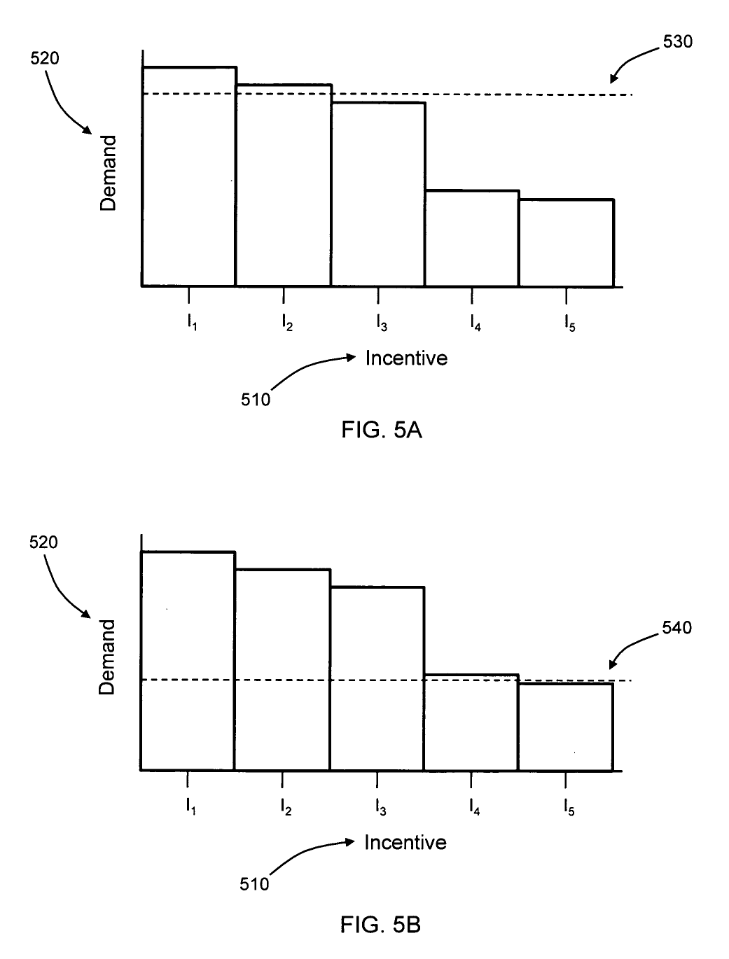

FIGS. 5A-B show example bar charts of estimated demand 520 as a function of incentive 510. In FIGS. 5A-B, the estimated demand 520 decreases as the incentive value 510 increases. In other words, the users of the community are incentivized to reduce their resource demand and consumption. By integrating the user rules with respect to an incentive amount, the aggregate demand of the community can be estimated. Changes to the incentive can affect changes to the aggregate demand. Similarly, changes to one or more user rules can also alter estimated and actual resource demands of the community.

FIGS. 5A-B show desired demands 530, 540 established by the utility manager. In a preferred embodiment, the desired demands 530, 540 are related to a supply of the resource managed by the utility manager. The desired demand 530 in FIG. 5A is high, possibly due to a large supply of the resource. Under this circumstance, the estimated demand will be below the desired demand 530 even with a small offer value of the incentive to the users of the community. In contrast, FIG. 5B shows a low desired demand 540, possibly due to shortages to the resource. Correspondingly, for a similar set of user rules of the community, the utility manager must offer an increased offer value to the users in order to have an estimated demand below the desired demand 540.

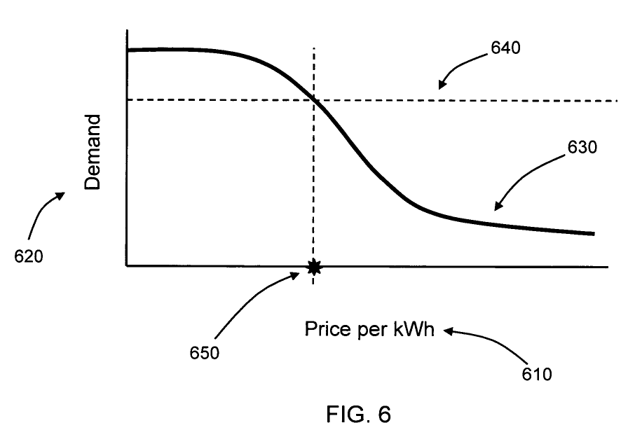

FIG. 6 shows an example continuous line graph 630 of the estimated demand 620 as a function of price per kWh of energy 610. The shape of the line 630 is determined by an aggregation of the user rules with respect to the price 610. In this example, the users of the community are less likely to demand power as the price of energy 610 increases. The desired demand 640 is equal to the estimated demand at a particular offer value 620 of the price 610. By controlling the offer value 620, the utility manager is able to influence user behavior to balance a demand for a resource with a desired amount or an available supply.

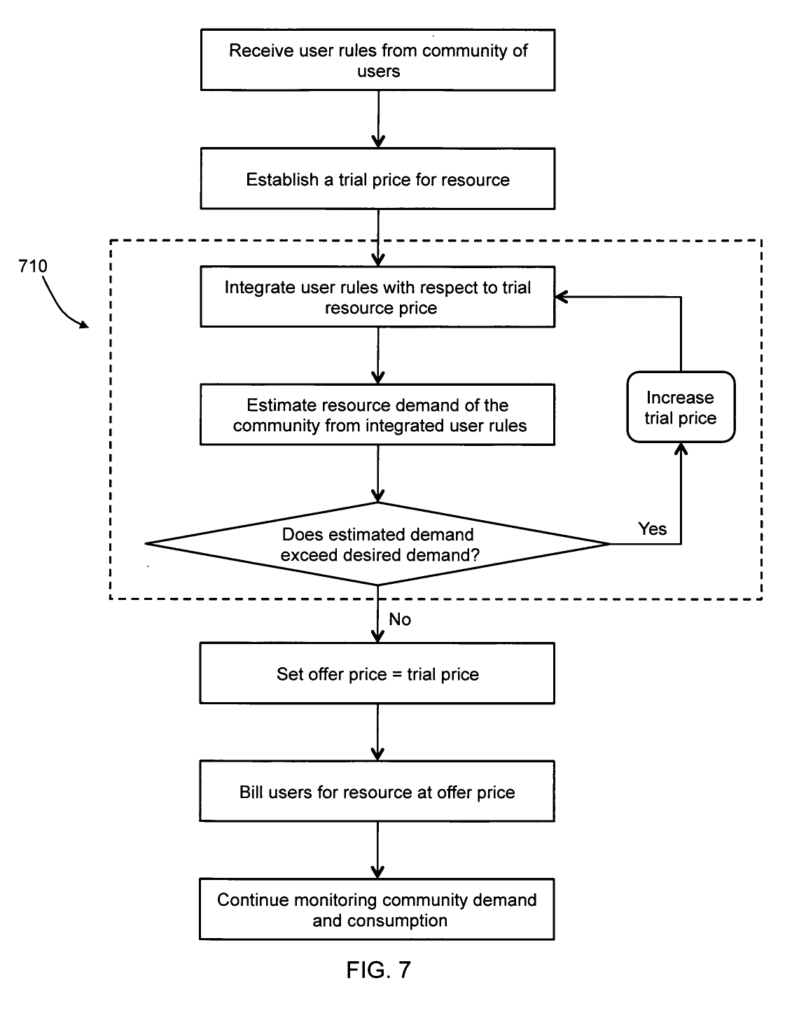

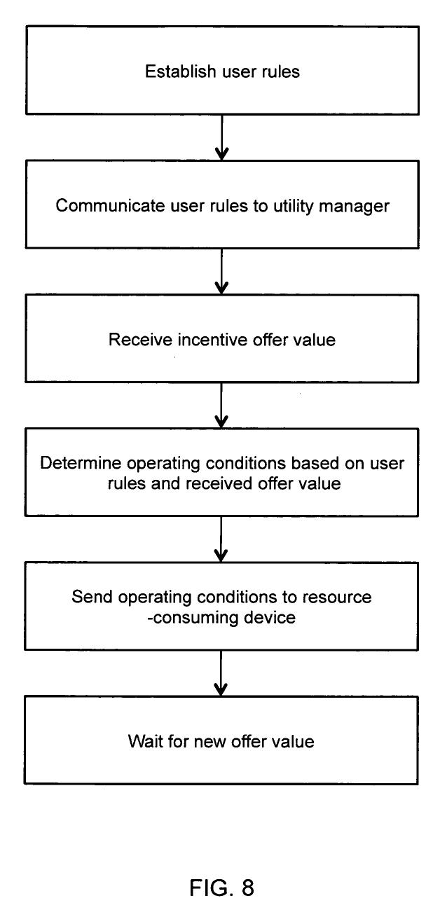

FIG. 7 shows a flow chart of an example process undertaken by a utility manager. In the embodiment of FIG. 7, the incentive includes a price for the resource. Importantly, the process includes one or more iterative loops 710 to enable the utility manager to establish an appropriate offer value. FIG. 8 shows a flow chart of an example process experienced by a user of the community.

As one of ordinary skill in the art will appreciate, various changes, substitutions, and alterations could be made or otherwise implemented without departing from the principles of the present invention, e.g. the users and utility manager are communicatively connected via any communication network, such as the Internet, a WAN, or a LAN, and the incentives can include any offers, penalties, or any means of influencing user behavior. Accordingly, the scope of the invention should be determined by the following claims and their legal equivalents.

What is claimed is:

1. In a community of a plurality of users, wherein each of said users has a resource-consuming device, wherein said resource-consuming devices of said users consumes a utility resource, a method of managing said utility resource for said community, said method comprising:
(a) receiving one or more users rules from each of said users of said community, wherein said user rules are established by said users of said community, wherein said user rules of each of said users are related to an operation of said resource-consuming device of the same of said users, and wherein said user rules are related to an incentive directed to said operation of said resource-consuming devices;
(b) establishing a trial value of said incentive;
(c) estimating a demand of said utility resource by said community based on said user rules of some or all of said users of said community and said value of said incentive;
(d) iterating steps (b) and (c) until said estimated demand reaches a desired demand, wherein an offer value of said incentive is established when said desired demand is reached; and
(e) communicating said offer value of said incentive to said users of said community.

2. The method as set forth in claim 1, wherein steps (b)-(d) of said method are accomplished continuously or periodically over time.

3. The method as set forth in claim 1, wherein said resource-consuming device of each of said users comprises a climate-controlling device, and wherein said user rules of each of said users are associated with one or more thermostat settings for operating said climate-controlling device.

4. The method as set forth in claim 1, wherein said utility resource comprises an energy resource, electricity, a gas, a natural gas, a petroleum resource, a water resource, or any combination thereof, and wherein said incentive comprises a financial incentive, a carbon credit, a price for said utility resource, a third party offer, or any combination thereof.

5. A method of managing a utility resource for a community of a plurality of users, said method comprising:
(a) providing a control module for each of said users of said community, wherein said control module controls a resource-consuming device of the same of said users, and wherein said resource-consuming device consumes said utility resource;
(b) providing a rules module for allowing each of said users of said community to establish one or more user rules, wherein said user rules comprise one or more conditions for operating said resource-consuming device of the same of said users, and wherein said user rules are related to an incentive associated with a usage of said utility resource;
(c) communicating said user rules of each of said users to a utility manager;
(d) iteratively establishing a trial value of said incentive and estimating a demand of said utility resource by said community until said estimated demand reaches a desired demand, wherein said estimating comprises aggregating said users rules of some or all of said users of said community with respect to said trial value of said incentive, and wherein an offer value of said incentive is established when said desired demand is reached; and
(e) offering said utility resource with said incentive to said community of users, wherein said incentive is offered at said offer value.

6. The method as set forth in claim 5, wherein said iteratively establishing said trial value of said incentive and estimating said demand are accomplished continuously or periodically over time, and wherein said offer value can be changed based on a change to said estimated demand, a change to one or more of said user rules, a change to said desired demand, or any combination thereof.

7. The method as set forth in claim 6, further comprising alerting one or more users of said community when said offer value is changed.

8. The method as set forth in claim 5, further comprising changing said desired demand and iterating step (d) based on said changed desired demand.

9. The method as set forth in claim 8, wherein said desired demand is changed based on a supply of said utility resource.

10. The method as set forth in claim 6, further comprising providing a thermostat for each of said users, wherein said resource-consuming device of each of said users comprises a climate-controlling device, wherein said thermostat is associated with said climate-controlling device of the same of said users, and wherein said user rules of each of said users are related to one or more settings on said thermostat.

11. The method as set forth in claim 6, wherein said utility resource comprises an energy resource, electricity, a gas, a natural gas, a petroleum resource, a water resource, or any combination thereof, and wherein said incentive comprises a financial incentive, a carbon credit, a price for said utility resource, a third party offer, or any combination thereof.

12. A utility resource management system, said system comprising:
(a) a community of a plurality of users, wherein each of said users has at least one resource-consuming device, and wherein said resource-consuming device consumes a utility resource;
(b) a rules module for allowing each of said users of said community to establish one or more user rules, wherein said user rules comprise one or more conditions for operating said resource-consuming device of the same of said users, and wherein said user rules are related to an incentive associated with a usage of said utility resource;
(c) a utility manager for establishing an offer value of said incentive, wherein said offer value establishing comprises one or more iterations of:
(i) establishing a trial value of said incentive; and
(ii) estimating a demand of said utility resource by said community of users, wherein said estimating comprises aggregating said user rules of some or all of said users of said community with respect to said trial value of said incentive,
wherein said iterations continue until said estimated demand reaches a desired demand, and wherein said offer value of said incentive is established when said desired demand is reached; and
(d) a communication network for said users to transmit said user rules to said utility resource manager and for said utility manager to transmit said offer value of said incentive to said users of said community.

13. The system as set forth in claim 12, wherein said utility manager can change said offer value based on a change to said estimated demand, a change to one or more of said user rules, a change to said desired demand, or any combination thereof.

14. The system as set forth in claim 13, further comprising an alert module to alert one or more users of said community when said offer value is changed, wherein said alert comprises an audio alert, a visual alert, or an audio-visual alert.

15. The system as set forth in claim 13, wherein said desired demand is changed based on a supply of said utility resource.

16. The system as set forth in claim 12, further comprising a thermostat for each of said users, wherein said resource-consuming device of each of said users comprises a climate-controlling device, wherein said thermostat is associated with said climate-controlling device of the same of said users, and wherein said user rules of each of said users are related to one or more settings on said thermostat.

17. The system as set forth in claim 16, wherein said thermostat of at least one of said users comprises a display for displaying a current temperature, said offer value of said incentive, and one or more of said thermostat settings.

18. The system as set forth in claim 16, further comprising a controller for each of said climate-controlling devices, wherein said controller is capable of activating and deactivating said climate-controlling device based on said user rules and said offer value of said incentive.

19. The system as set forth in claim 12, wherein said utility resource comprises an energy resource, electricity, a gas, a natural gas, a petroleum resource, a water resource, or any combination thereof, and wherein said incentive comprises a financial incentive, a carbon credit, a price for said utility resource, a third party offer, or any combination thereof.

20. The system as set forth in claim 12, wherein said community comprises a building having multiple units, an apartment building, an office building, a retail development, a neighborhood, a housing development, an urban development, a suburban development, a district, a utility district, a city, a county, or any combination thereof.
